(19) United States
(12) Patent Application Publication
(10) Pub. No.: US 2026/0124530 A1
(43) Pub. Date: May 7, 2026

(54) DRONE-BASED MOBILE GAMING PLATFORM

(71) Applicant: Sony Interactive Entertainment Inc., Tokyo (JP)

(72) Inventors: Zade Lobo, San Mateo, CA (US); Ayush Raina, San Mateo, CA (US); Hubert Lu, San Mateo, CA (US); Kusha Sridhar, San Mateo, CA (US); Hideaki Iwaki, San Mateo, CA (US)

(21) Appl. No.: 18/940,704

(22) Filed: Nov. 7, 2024

(51) Int. Cl. A63F 13/27

(52) U.S. Cl. CPC A63F 13/27

(57) ABSTRACT

A swarm of drones over a large open area or stadium project portions of computer game video onto the ground or a wall in the area. The drones are controlled by a hub to present a game played on phone or controller to gamify any space.

### FIELD

The present application relates generally to drone-based mobile gaming platforms.

### BACKGROUND

With the increasing complexity of computer games or video games, the possibilities of game design that integrates devices not heretofore used in computer games presents itself.

### SUMMARY

Accordingly, An apparatus includes a swarm of drones each having a respective video projectors to project portions of a computer game onto an area when the swarm of drones overflies the area. At least one hub device is configured for wireless communication with the drones to control the drones as they overfly the area.

In some examples the hub device includes a processor system configured to receive demanded video images from a game engine and send respective portions of the demanded video images to respective drones to project the respective portions. In such examples the processor system of the hub device can be configured to cause at least some of the portions to be projected by the drones into respective regions of the area that are contiguous to each other, with the portions establishing at least one complete frame of computer game video.

In non-limiting examples the processor system of the hub device may be configured to cause at least two drones to project a first portion into the area.

If desired, the portions can have a same size and shape as each other or they may not have a same size and shape as each other.

In example implementations, the processor system of the hub device can be configured to cause the drones to project their respective portions onto the ground. In other implementations the processor system of the hub device may be configured to cause the drones to project their respective portions onto a vertical surface.

In certain embodiments the processor system of the hub device can be configured to, responsive to a first drone projecting a first portion onto a first region and reporting low battery voltage, cause a substitute drone to project the first portion onto the first region. In some embodiments the processor system of the hub device can be configured to, responsive to a first game object having a first importance, cause plural drones to project images of the first object onto a first region.

In examples, the processor system of the hub device can be configured to, responsive to a first drone projecting a first portion onto a first region and indicating a blockage, cause a substitute drone to project the first portion onto the first region.

In another aspect, an apparatus includes computer memory that is not a transitory signal and that in turn includes instructions executable by at least one processor system to control flight paths for plural drones over an area, and control video projection from the drones into the area.

In another aspect, a method includes controlling flight paths of plural drones, and controlling projection of video portions from the drones such that the drones together project into an area a computer game.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example drone swarm system consistent with present principles;

FIG. 3 illustrates drones projecting portions of game video into an area;

FIG. 4 illustrates example logic in example flow chart format;

FIG. 5 illustrates additional example logic in example flow chart format;

FIG. 6 illustrates a drone swarm in a large sphere projecting video onto the sphere;

FIG. 7 illustrates a drone swarm projecting video onto a wall in an area; and

FIG. 8 illustrates a drone swarm projecting video onto the ground in an area.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

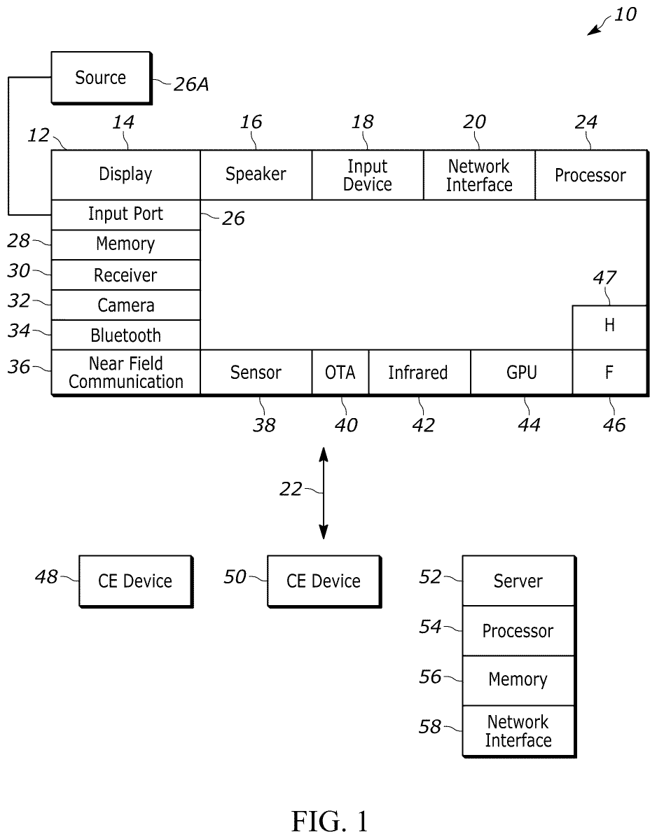

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative models such as large language models (LLM) such as generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

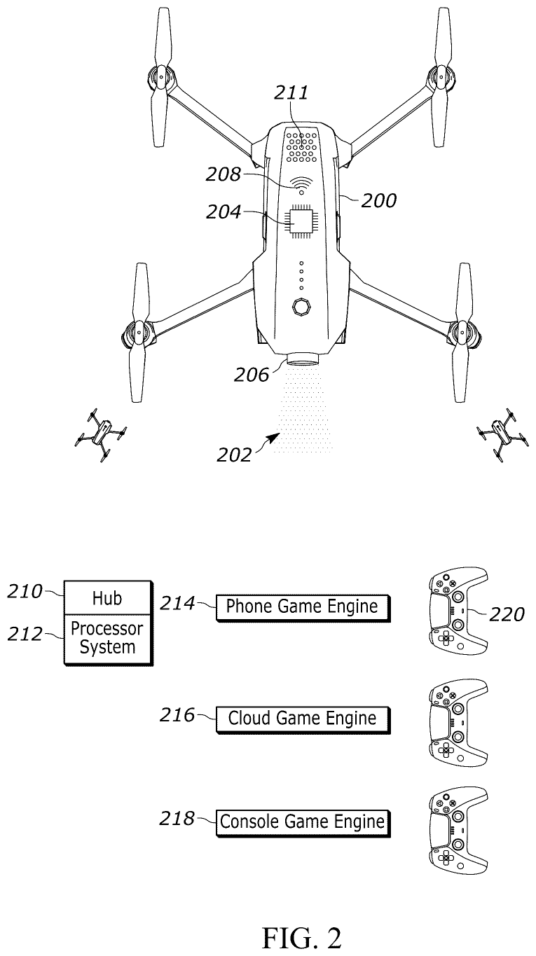

Refer now to FIG. 2. Plural drones 200, typically battery-powered, overfly an area 202. Each drone 200 may include an onboard processor system 204 controlling one or more video projectors 206 which may be movable to project video such as computer game video into the area 202 under control of signals received via a wireless communication interface 208 from one or more typically ground-based hubs 210 (only a single hub shown), although in some embodiments the hub 210 may be borne on another drone. Wireless communication between the hub and the drones may be via Wi-Fi, wireless telephony, or other suitable wireless protocol. One or more drones 200 also may include one or more speakers 211 to emit computer game audio into the area 202.

The hub 210 may include its own processor system 212. The hub 210 can receive demanded video images from a game engine that may be hosted on a phone or tablet computer 214, and/or a cloud server 216, and/or a computer game console 218. The game may be controlled by one or more players operating respective computer game controllers 220 or other control devices such as wireless phones. The hub 210 can partition each frame of the demanded video images into portions and assign each portion to a respective drone or drones, sending to each drone its assigned video portion to project into the area 202.

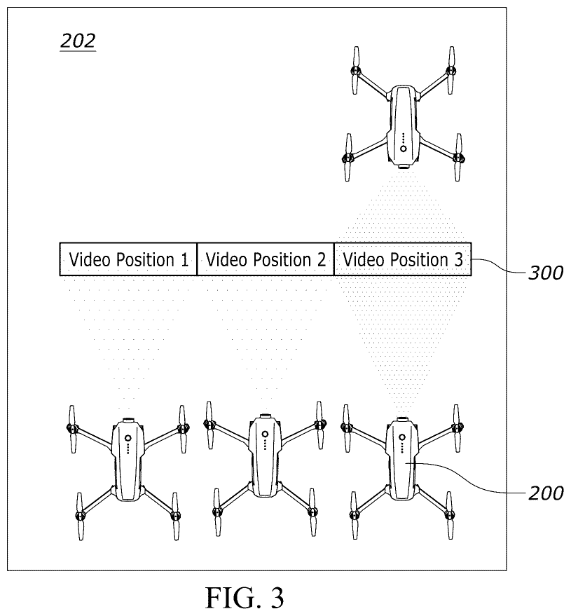

FIG. 3 illustrates the drones 200 overflying the area 202 to project respective computer game video portions 300 into the area 202. As shown, the video portions 300 can be contiguous to each other, and it is to be appreciated that contiguous portions 300 together make up a complete frame of computer game video. As also shown in FIG. 3, plural drones may project the same video portion as each other, in the example shown, video portion 3. In this way the brightness of video portion 3 may be greater than the brightness of the other video portions. The video portions may be the same size and shape as each other or they may have different sizes or shapes.

As the drones fly, the processor systems herein may move the projectors on the drones to maintain the respective projected video portions to be fixed, i.e., to not move across the surface onto which they are projected as the drones move. In other embodiments, the video portions may move but may do so in concert with each other so the combined video established by the portions does not become disjoint. In still other embodiments each drone may project its own video portion into the area 202 independently of where the other drones project their video.

Accordingly, a swarm of drones 200 may fly over a large open area or stadium to project respective portions of computer game video onto the ground or a wall in the area. The drones are controlled by a hub to present a game played on phone or controller to gamify any space.

Note that while examples below contemplate the drones projecting video onto the ground or a wall such as a building, the video need not be projected onto a surface and can be projected into thin air around the people in the area.

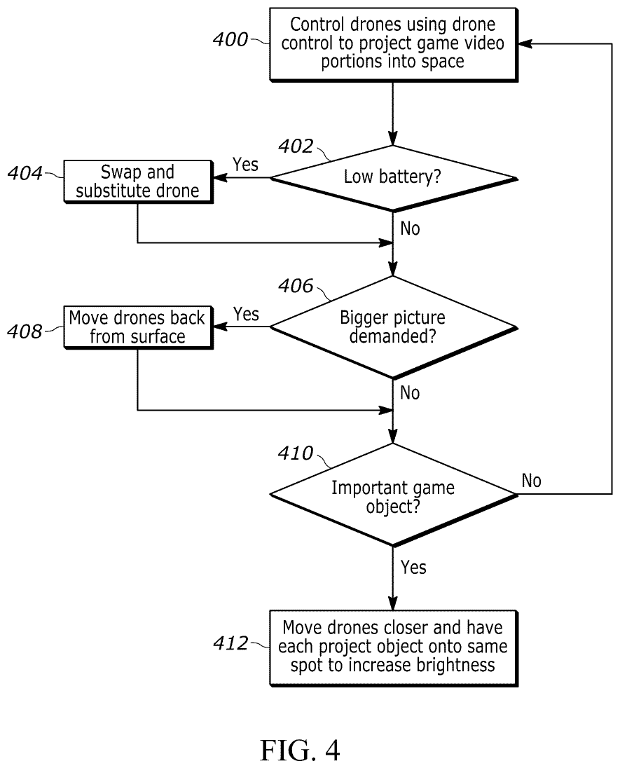

Commencing at state 400 in FIG. 4, the drones 400 are controlled both in terms of flight path and what video to project using drone control algorithms executed by the hub 202 to project a computer game video in the area 202. Since the location and flight path of each drone is known and controlled along with the specific video portion assigned to the drone, as the drone flies the hub can move the projector of the drone to remain fixed on a specific location in the area 202 whose coordinates also are known, e.g., using an electronic map. The hub can ensure in this manner that each respective video portion remains in a location contiguous to other video portions as the video is being projected by the drones.

If it is determined at state 402 that a drone is low on fuel (or battery voltage), a substitute drone can be swapped in for the expiring drone at state 404. The substitute drone can be flown to the location of the expiring drone and then assigned to project the video portion of the expiring drone onto the location in the area 202 that the expiring drone was projecting video. The expiring drone can then be retired to refuel.

State 406 indicates that it may be determined that a larger total video picture is demanded than currently had been the case, in which case the logic moves to state 408 to move the drones further away from the respective locations in the area 202 they were assigned to project video into while continuing to project their assigned video portions into the respective locations in the area 202. The resulting decrease in brightness can be compensated for by using more drones such as is illustrated in FIG. 3, showing two drones projecting the same video portion onto the same location.

Similarly, as indicated at state 410 if it is determined that a particular game object is more important than other objects, e.g., a player character may be more important than surrounding background images, either more drones may be used at state 412 to project the video portion containing the important object and/or the drone or drones projecting the video portion containing the important object can be moved closed to the location they are projecting video on to.

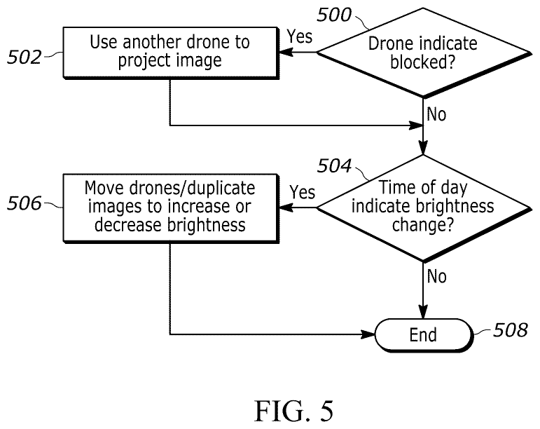

FIG. 5 illustrates additional logic. If it is determined at state 500 that a drone is blocked from projecting its assigned video portion onto its assigned location as indicated by, e.g., machine vision executed on images from the drone, another drone may be used at state 502 to project the blocked drone's video portion onto the assigned area. For example, a person may have moved between the drone and its assigned projection location.

State 504 indicates that if it is determined that a time of day indicates a change in brightness of the video should be effected, the logic may move to state 506 to moves the drones toward or away from their assigned projection locations as appropriate and/or use more drones to project the image to increase brightness. Thus, brightness can be decreased from a daytime projection brightness to a lower dusk brightness, then again to a yet lower nighttime brightness, then again increased with the onset of day.

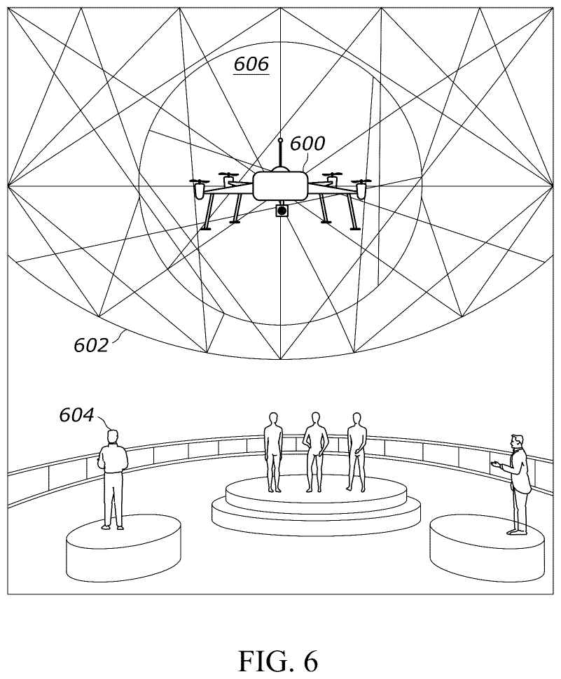

FIGS. 6-8 illustrate example scenarios. In FIG. 6, plural drones 600 fly within a large sphere 602 in which spectators 604 observe the drones projecting in concert with each other a video image 606 (in the example shown, a globe) onto the inside wall of the sphere 602. While the term “sphere” is used, the arena or stadium shown may be more precisely hemispherically-shaped.

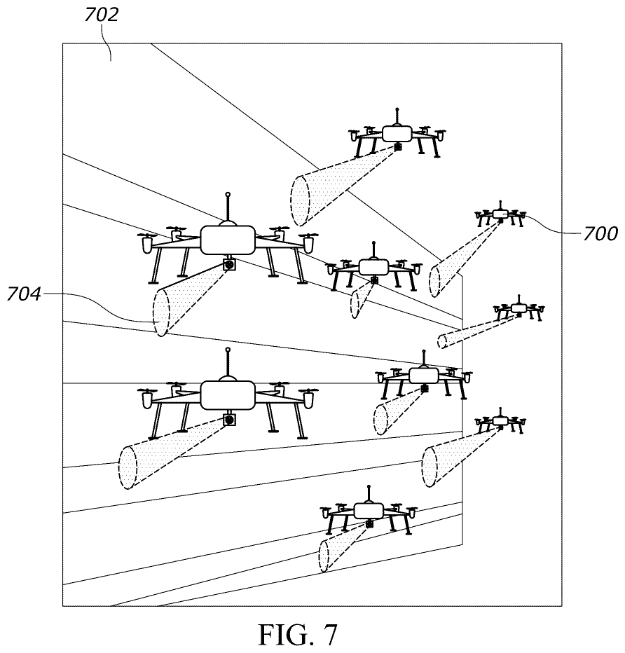

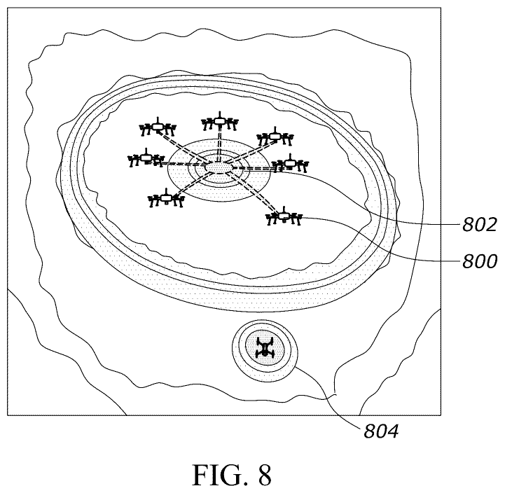

FIG. 7 illustrates a swarm of drones 700 flying in an area to project respective video portions 702 onto a vertical surface 704 in the area, such as a wall of a building. On the other hand, in FIG. 8 plural drones 800 are overflying an area and projecting their respective video portions 802 onto the ground 804 of the area.

It may now be appreciated that the drone-based techniques herein provide a mobile gaming platform in which the area onto which a computer game is projected may be established to be anywhere the drones can fly.

While the particular embodiments are herein shown and described in detail, it is to be understood that the subject matter which is encompassed by the present invention is limited only by the claims.

What is claimed is:

1. An apparatus comprising:
a swarm of drones each having a respective video projectors to project portions of a computer game onto an area when the swarm of drones overflies the area; and
at least one hub device configured for wireless communication with the drones to control the drones as they overfly the area.

2. The apparatus of claim 1, wherein hub device comprises a processor system configured to receive demanded video images from a game engine and send respective portions of the demanded video images to respective drones to project the respective portions.

3. The apparatus of claim 2, wherein the processor system of the hub device is configured to cause at least some of the portions to be projected by the drones into respective regions of the area that are contiguous to each other, the portions establishing at least one complete frame of computer game video.

4. The apparatus of claim 2, wherein the processor system of the hub device is configured to cause at least two drones to project a first portion into the area.

5. The apparatus of claim 1, wherein the portions have a same size and shape as each other.

6. The apparatus of claim 1, wherein the portions do not have a same size and shape as each other.

7. The apparatus of claim 2, wherein the processor system of the hub device is configured to cause the drones to project their respective portions onto the ground.

8. The apparatus of claim 2, wherein the processor system of the hub device is configured to cause the drones to project their respective portions onto a vertical surface.

9. The apparatus of claim 2, wherein the processor system of the hub device is configured to, responsive to a first drone projecting a first portion onto a first region and reporting low battery voltage, cause a substitute drone to project the first portion onto the first region.

10. The apparatus of claim 2, wherein the processor system of the hub device is configured to, responsive to a first game object having a first importance, cause plural drones to project images of the first object onto a first region.

11. The apparatus of claim 2, wherein the processor system of the hub device is configured to, responsive to a first drone projecting a first portion onto a first region and indicating a blockage, cause a substitute drone to project the first portion onto the first region.

12. An apparatus comprising:
computer memory that is not a transitory signal and comprising instructions executable by at least one processor system to:
control flight paths for plural drones over an area; and
control video projection from the drones into the area.

13. The apparatus of claim 12, wherein the video projection establishes presentation of a computer game.

14. A method, comprising:
controlling flight paths of plural drones; and
controlling projection of video portions from the drones such that the drones together project into an area a computer game.

15. The method of claim 14, comprising:
causing at least some of the video portions to be projected by the drones into respective regions of the area that are contiguous to each other.

15. The method of claim 14, comprising causing at least two drones to project a first video portion into the area.

16. The method of claim 14, comprising causing the drones to project their respective video portions onto the ground.

17. The method of claim 14, comprising causing the drones to project their respective video portions onto a vertical surface.

18. The method of claim 14, comprising, responsive to a first drone projecting a first video portion onto a first region and reporting low battery voltage, causing a substitute drone to project the first video portion onto the first region.

19. The method of claim 14, comprising, responsive to a first game object having a first importance, causing plural drones to project images of the first object onto a first region.

20. The method of claim 14, comprising, responsive to a first drone projecting a first video portion onto a first region and indicating a blockage, causing a substitute drone to project the first video portion onto the first region.
